(19) United States
(12) Patent Application Publication
(10) Pub. No.: US 2024/0261862 A1
(43) Pub. Date: Aug. 8, 2024

(54) ADDITIVE MANUFACTURING PROCESS AND PRODUCT OBTAINABLE THROUGH THE PROCESS

(71) Applicants: POLITECNICO DI TORINO, Torino (IT); UNIVERSITA' DEGLI STUDI DI MODENA E REGGIO EMILIA, Modena (IT)

(72) Inventors: Manuela Galati, Torino (IT); Elena Bassoli, Modena (IT); Andrea Gatto, Modena (IT); Luca Iuliano, Torino (IT)

(21) Appl. No.: 18/565,858

(22) PCT Filed: Jun. 9, 2022
(86) PCT No.: PCT/IB2022/055368

§ 371 Date: Nov. 30, 2023

(30) Foreign Application Priority Data
Jun. 10, 2021 (IT) 102021000015218

(51) Int. Cl. B22F 10/38; B22F 10/28; B22F 10/85; B33Y 10/00; B33Y 50/02; B33Y 80/00

(52) U.S. Cl. CPC B22F 10/38; B22F 10/28; B22F 10/85; B33Y 10/00; B33Y 50/02; B33Y 80/00

(57) ABSTRACT

An additive manufacturing process for manufacturing a solid body designed to be delimited by a predefined outer surface includes selecting at least one volume portion of the solid body, preparing a three-dimensional model of the solid body by means of a computer, in which the selected volume portion is modelled independently of the rest of the solid body, supplying the model in a suitable data interface format to the processing unit of an additive manufacturing machine, and operating the additive manufacturing machine for producing the solid body according to the model, thus obtaining the predefined outer surface.

### CROSS-REFERENCE TO RELATED APPLICATIONS

This patent priority of Italian Patent Application No. 102021000015218 filed on Jun. 10, 2021, the entire disclosure of which is incorporated herein by reference.

### TECHNICAL FIELD OF THE INVENTION

The invention concerns an additive manufacturing process of a product, in addition to the product itself obtained by means of the additive manufacturing process.

### STATE OF THE ART

The expression additive manufacturing is commonly used to identify a plurality of industrial processes for manufacturing three-dimensional products.

Additive manufacturing is carried out by overlapping layers of material on one another rather than by the subtraction of material, as in the case of manufacturing processes by chip removal.

Known examples of additive manufacturing technologies are stereolithography, fused deposition modelling, laser sintering, electron beam fusion, etc.

According to the type of technology, the starting material for obtaining the layers can generally be in a liquid state, a semi-solid state as in the case of a paste, or solid in the form of powder, for example.

Furthermore, additive manufacturing technologies can be used to process various types of materials, for example metallic materials and plastic materials.

A typical additive manufacturing process begins by importing a 3D mathematical model of the product to be manufactured into a processing unit of an additive manufacturing machine. Usually, the mathematical model is contained in a digital file in STL format. The STL format is a common interface data format for the known additive manufacturing machines.

Based on the machine programming algorithms, the processing unit automatically plans production of the layers and overlapping the layers on one another so as to obtain a product corresponding to the imported model.

Normally, the layers are overlapped on one another according to the direction of their thickness, namely in the machine construction direction.

If necessary, the processing unit also plans the provision of supports designed to sustain the material during manufacturing, so as to avoid for example burrs or collapses of localized portions during the addition of material. As known, the supports do not form part of the product to be manufactured and must be removed following the additive manufacturing process. The function of the supports is well-known in the technical sector of additive manufacturing.

The provision of the supports may also be controlled by an operator interacting manually with the processing unit in an appropriate manner.

In view of the above, the additive manufacturing processes are highly automated and dependent on the algorithms stored in the processing units of the specific machines available on the market.

The operator has the possibility to intervene in the process, however, by setting some process parameters typical of the machine used.

For example, in the case of the electron beam fusion technology, the operator can set the beam focus deviation, the beam current, the beam speed, the number of beam passages, etc.

Some of the process parameters that can be set can influence the properties of the manufactured product, for example the final density, the thermal or electric conductivity and similar.

Nevertheless, the algorithms of the processing units are programmed specifically so that every portion of the manufactured product is uniformly dense, independently of selection of the process parameters by the operator.

This could give rise to a need to increase the versatility of the additive manufacturing processes.

In fact, although the known additive manufacturing processes are optimized according to criteria commonly shared in the sector, the need is felt to further improve said processes in terms of versatility, in order to obtain consequently improved products or products with new functions with respect to those that can be obtained with traditional technologies.

Furthermore, the need is also felt for any improvements not to affect in any way the aesthetic result of the products manufactured, the outer form of which must remain substantially faithful to the design.

### SUBJECT AND SUMMARY OF THE INVENTION

One object of the invention is to meet the above needs, preferably in a simple and inexpensive manner.

According to the invention, an additive manufacturing process and a product obtainable through the process are achieved as defined by the independent claims.

The dependent claims define particular embodiments of the invention.

The invention allows to obtain products including inner portions not completely densified, namely with a lower densification level than the surrounding portions, contrarily to the technical requirement establishing that it is essential for the product to be uniformly densified.

The outer form and the final appearance, namely the outer surface of the product, remain unchanged with respect to the required design conditions.

The possibility of manufacturing portions with lower densification allows active programming of the breakage areas under stress; in this way, any breakage of the product will occur in a predictable manner in a desired area of the product.

This favours maintainability and reliability of the product.

Furthermore, the product can be used and therefore defined as a protection device for protecting surrounding structures from potential overloads.

Furthermore, the invention allows preferential paths to be traced within the product for thermal and/or electrical flows by controlling the density of the inner portions of said product.

Similarly, it is possible to influence the propagation path of potential cracks in the areas most probably affected by defects.

Summarizing, the invention allows a localized control of the properties, for example mechanical, thermal, electrical, of each area of the product, thus obtaining predictable behaviour of the product in use.

### BRIEF DESCRIPTION OF THE DRAWINGS

For a better understanding of the invention, a specific embodiment is described below by way of non-limiting example and with reference to the attached drawings, in which

FIG. 1 is a front view of a product to be manufactured with a process according to the invention;

FIG. 2 is a front view representation of a model of the product prepared according to a step of the process according to the invention;

FIG. 3 shows a detail of FIG. 2;

FIGS. 4-7 are analogous to FIG. 3 and show models alternative to the model of FIG. 3;

FIG. 8 is a stress-strain diagram relative to further products obtained with the process according to the invention using the models of FIGS. 3-7;

FIG. 9 illustrates an image acquired by means of electron microscope of a fracture surface of the product of FIG. 1, manufactured with the process according to the invention;

FIG. 10 is a local enlargement of the image of FIG. 9; and

FIG. 11 illustrates an image acquired by means of electron microscope of a fracture surface of a product manufactured with a process of the known art in conditions corresponding to those in which the product of FIG. 10 is obtained.

### DETAILED DESCRIPTION OF PREFERRED EMBODIMENTS OF THE INVENTION

The description and the drawings will refer, without any loss of generality, to an additive manufacturing process of a tensile test specimen. The specific process described and illustrated 30 uses an electron beam fusion technology applied on metal powder.

Therefore, an additive manufacturing machine that operates according to this technology will be considered here in the description, although not illustrated.

Alternatively to what is described below, the process of the invention, defined by the claims, could use any additive manufacturing technology, applied on any suitable material, to manufacture a solid product having any form that can be produced by means of additive manufacturing.

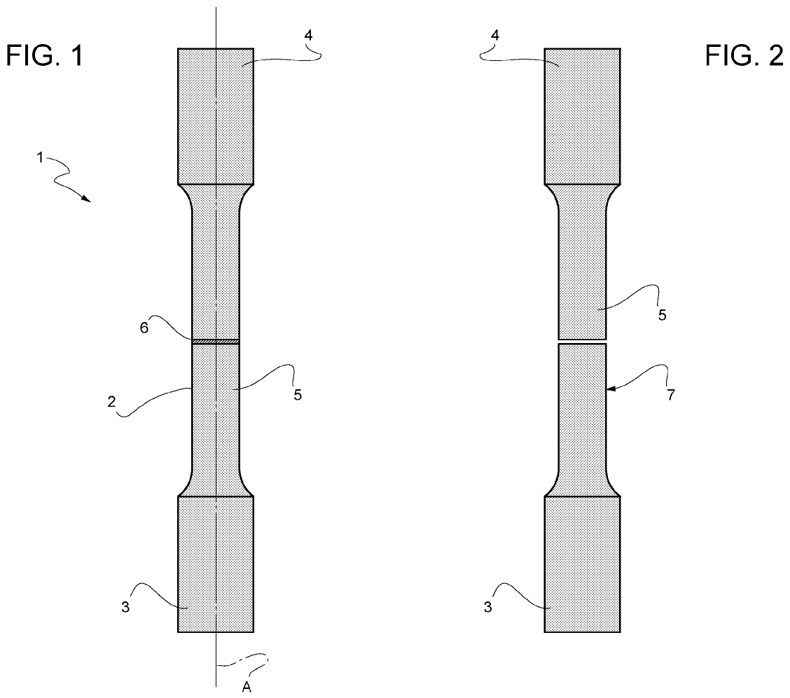

In FIG. 1, the reference number 1 indicates a product comprising a solid body 2 which, in particular, defines a tensile test specimen. The product may comprise several solid bodies instead of one.

More in particular, the body 2 extends along an axis A between two opposite ends 3, 4. Furthermore, the body 2 comprises an intermediate portion 5 having a cross-section with reduced dimensions with respect to those of the ends 3, 4.

The body 2 has been designed as in the representation of FIG. 1. In other words, the body 2 has a predetermined aesthetic aspect or exterior form. According to the design of the body 2, the outer surface of the latter is predefined and delimits said body 2.

An additive manufacturing process of the body 2 must substantially comply with the design; in particular, the body 2 produced according to the process must substantially have the designed outer surface.

The process comprises the preparation of a three-dimensional model of the body 2 by means of a computer. More precisely, the model is a mathematical model in digital format, for example obtained via the use of a software for computer-aided technical drawing. In preparation of the model, the process comprises the selection of at least a volume portion 6 of the body 2.

In FIG. 1, the portion 6 is highlighted for clarity with a different colour shade from the remaining part 7 of the body 2. However, the portion 6 forms an integral part of the body 2, without interruption with respect to the part 7.

The portion 6 has a precise position in the body 2 and is surrounded at least partially by the part 7. In particular, the portion 6 is part of the intermediate portion 5.

The portion 6 is deliberately selected so that it is weakened with respect to the part 7, downstream of the manufacturing process. Specifically, the portion 6 has a lower densification level than the part 7, namely it is less densified. More precisely, the density of the portion 6 is advantageously lower than that of the part 7.

In this way, the reduced density of the portion 6 entails the existence of a specific load for which the manufactured body 2 would be subject to a breakage or fracture at the portion 6 in a programmed and predictable manner. The specific load is lower than a load necessary to cause breakage of the part 7.

The specific load is variable, for example, according to the form and/or dimensions of the portion 6. Therefore, the selection and consequent modelling of the portion 6 can be carried out as a function of a desired load or correlated physical quantity, i.e. indicative of the desired load, so that said portion 6 undergoes breakage.

Therefore, the desired load or the correlated quantity, for example the elongation/strain, can be predicted in advance or chosen to select and model the portion 6 accordingly.

The portion 6 can be modelled as an empty space, for example. FIG. 2 shows the model prepared according to this latter example, with the empty portion 6 in its correct position, namely in the corresponding position or arrangement of FIG. 1, which shows the body 2 as designed.

According to a different example, not illustrated, the portion 6 can be modelled as solid, more precisely as an independent body with respect to the part 7. Although separate from the part 7, the portion 6 would be positioned correctly inside the model, namely in the corresponding position or arrangement of FIG. 1. In detail, the arrangement of the portion 6 could be contiguous or adjacent to the part 7 thus seemingly re-forming the body 2 in its entirety, according to the design conditions. Indeed, the outer surface of the body 2 thus modelled would be substantially equal to the outer surface predefined for the body 2.

In other words, the model would preferably have a predefined outer surface. Conveniently, the model also forms a complete representation of the inside of the body 2.

In this different example, as will become clearer below, obtaining the reduced densification entails intervening on one or more process parameters of the additive manufacturing machine used in order to influence the densification of the portion 6 and the part 7.

In this case, also the process parameters, in addition to the form and/or dimensions of the portion 6, will influence the specific load causing breakage of the portion 6. Therefore, once the desired load or the correlated quantity is determined, the process parameters can be determined together with the form and/or dimensions of the portion 6 to obtain the programmed breakage with the desired load.

Once the model has been prepared, it can be imported into a processing unit of the additive manufacturing machine. Naturally, the model could be already present, stored or provided in any way in the processing unit. The model is set in a data interface format readable by the processing unit. For example, the STL format is suitable.

At this point, the additive manufacturing machine is operated to produce the body 2 according to the model.

In the example of FIG. 2, a part of the predefined outer surface, corresponding to an outer surface of the portion 6, is absent in the model since the portion 6 is modelled as an empty space and comprises said part of the predefined outer surface. In other words, the portion 6 extends until it comprises the part of the outer surface.

In this particular case, the dimensions of the portion 6 or of the surface missing in the model along the axis A, namely along the machine construction direction, will simply have to be small enough for the predefined outer surface to be produced as a result of the heat developed by the machine before, during or after manufacture of the part 7, i.e. by thermal effect.

Furthermore, the thermal effects or the heat developed can be purposely accentuated by exploiting known functions of the machine, in particular pre-heating programs upstream of the manufacturing process and/or post-heating programs downstream of manufacture of the part 7 or of the portion 6. More in particular, the pre-heating and post-heating programs are applied upstream and downstream of the manufacture of a single layer that can be manufactured by the machine. The operator can select the application of the pre-heating and post-heating programs for one or more specific layers that can be manufactured by the machine.

In addition, said known functions can be adopted to influence densification of the portion 6 in a controlled manner.

The dimensions sufficient to completely obtain the outer surface will depend on the machine used. An operator or a dedicated algorithm can easily verify the maximum dimension limit whereby the thermal phenomena are no longer sufficient for or able to allow complete production of the outer surface. The operator or the algorithm can verify the above starting from a reasonable order of magnitude, for example a millimetre, and progressing towards gradually lower values, in a certain and reliable manner. The algorithm or the applicable verification rationale would therefore be based on a simple linear programming operation with certain result for which numerous known methods are available.

On the other hand, if the portion 6 were an inner volume portion with respect to the outer surface, the machine would reproduce the outer surface regardless of the dimensions of the portion 6.

Thanks to the presence of the empty space modelled in the area of the portion 6, the additive manufacturing machine performs an incomplete treatment of the material in the area of said portion 6. Therefore, the manufactured portion 6 is significantly less densified than the part 7.

In other words, the density of the portion 6 is lower than that of the part 7, i.e. the relative density of the portion 6 with reference to the part 7 is below one, for example, below 0.8.

Furthermore, the manufactured portion 6 is densified in a non-uniform manner due to the simultaneous presence of areas of material at least partially coupled, more precisely welded, to the material of the part 7, and areas of material completely separate or disunited or detached from the material of the part 7.

The areas of welded material can also be called, in technical jargon, “weld necks” which are formed in the portion 6.

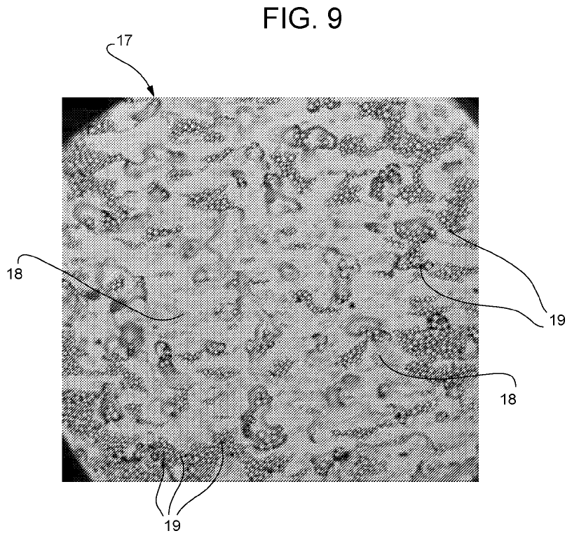

An example of manufacture of the portion 6 with the process described is provided in FIG. 9. FIG. 9 shows a breakage surface 17, of the manufactured body 2, at the portion 6. The surface highlights areas 18 having a plurality of weld necks, in this case, at least partially molten metal powder. Furthermore, the surface highlights further areas 19, also having weld necks, in which the original link between the portion 6 and the remaining part 7 was weaker than the areas 18.

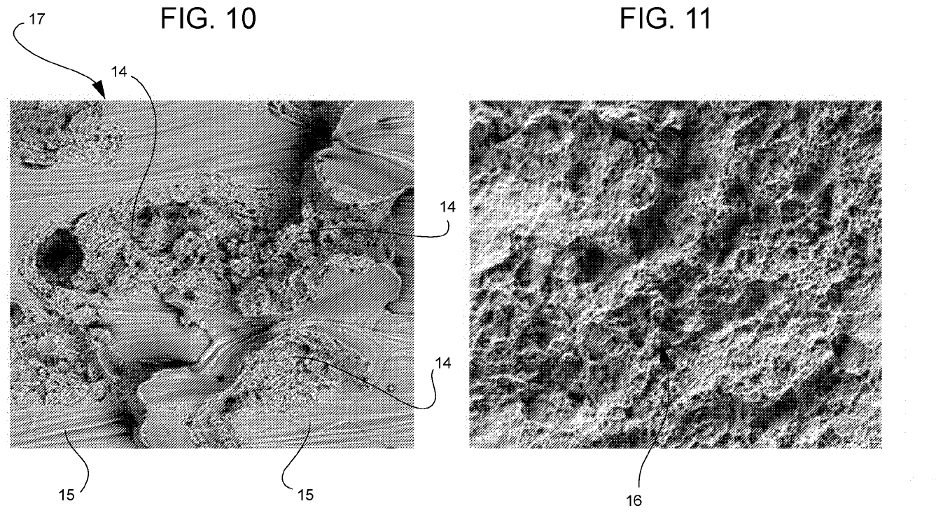

The result of the process can also be observed by comparing FIG. 10, which is a localized enlargement of FIG. 9, with FIG. 11. FIG. 11 shows a solid body produced with a known-art additive manufacturing process. The solid body of FIG. 11 underwent fracture after tensile test in conditions analogous to those of the body 2.

FIG. 10 shows the fracture surface 17 with portions having irregular geometry 14, corresponding to the weld necks 18, and substantially flat and smooth portions 15. In other words, the surface 17 simultaneously has areas in which the densified material has collapsed (portions 14) and areas in which no breakage was observed (portions 15).

The portions 15 correspond substantially to the areas of disunited material of the portion 6. Here, in other words, the material was not cohesive before performance of the tensile test, namely before any application of loads.

This is the result of only the partial densification of the portion 6.

The expression “flat and smooth” indicates, for example, that the portions 15 correspond to the areas for which the process does not cause densification of the material.

In particular, the portions 15 would correspond to dark areas in tomographic images or to porosities in metallographic sections.

The portions 14 show, on the other hand, the typical morphology of collapse of a portion of densified metallic material which is brought to breaking point.

Vice versa, FIG. 11 shows a completely irregular fracture surface 16, characteristic of a completely densified component.

The applicant has experimentally observed that the characteristics highlighted in FIGS. 9 and 10 are found in a generality of different products, also by applying additive manufacturing technologies different from electron beam fusion.

In the case of the different example in which the portion 6 is modelled as solid, the different densification of the portion 6 is obtained by selecting at least one process parameter of the machine and applying differently the process parameter selected for production of the portion 6 and the part 7. Clearly, the process parameter selected is suitable for influencing the densification of the portion 6 and the part 7.

In this last example, the different densification can be more finely controlled. For example, the manufactured portion 6 can be uniformly densified, with a density lower than that of the part 7. The manufactured portion 6 can also be densified in a non-uniform manner, and could therefore comprise areas of material coupled to the part 7 and areas of material disunited or independent of the part 7. Clearly, also in this last example, the manufactured portion 6 would be weakened with respect to the part 7.

The term weakened identifies a structure with mechanical strength inferior to the nominal mechanical strength of the material, treated with a traditional additive manufacturing process.

Specific examples of process parameters that can be considered for the technology of electron beam fusion are focus deviation, current, speed, and the number of passages of the electron beam. The influence of the listed parameters on the densification is known in the sector, and therefore does not require further detailed explanations.

Preferably, the portion 6 is stratiform, namely it forms a layer, which is empty in the case of FIG. 2.

The portion 6 has a thickness G which extends along the axis A, which corresponds in particular to the machine construction direction.

The term “thickness” should be understood as oriented in the direction of minimum extension of the portion 6.

By machine construction direction we mean the direction in which the layers manufactured by the machine are overlapped during the additive manufacturing process.

During the process, the machine can automatically orient the model with respect to a reference system of said machine. The reference system includes, for example, the construction direction.

The automatic orientation criteria are known and predictable. For example, a possible criterion is that of aligning the direction of maximum extension of the model with the construction direction. Otherwise, the orientation of the model can be set by the operator interacting with the processing unit.

The portion 6 can be selected so that the direction of the thickness G corresponds to or coincides with the construction direction, for example based on the automatic orientation criteria or coherently with the operator's settings.

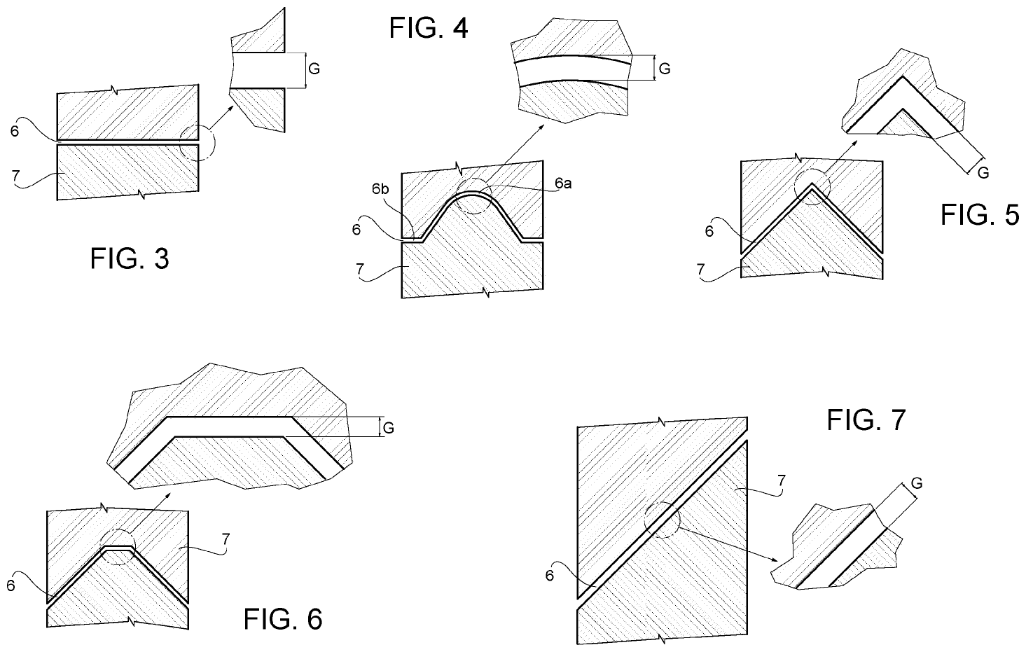

In the example of FIG. 2, corresponding to the example of FIG. 3, the portion 6 extends throughout the extension of the body 2 in two directions orthogonal to the axis A, namely in the construction direction. In fact, as mentioned previously, the portion 6 includes a part of the outer surface of the body 2.

Preferably, the thickness G of the portion 6 is uniform, for example in directions parallel to the construction direction. Alternatively, the thickness G could vary, for example again in parallel directions.

In other words, considering the thickness G as a function of two length variables according to respective axes orthogonal to each other and orthogonal to the construction direction, said thickness G can be constant in the construction direction or variable.

FIGS. 2 and 3 show an example in which the portion 6 has a rectangular cross-section. In particular, the portion 6 has a cylindrical shape.

Alternatively, the portion 6 can have a cross-section with a different shape. FIGS. 4-7 illustrate a plurality of possible examples.

FIG. 4 illustrates the portion 6 having an omega-shaped cross-section. In particular, the portion 6 comprises a dome 6a, for example hemispherical. In this case, the thickness G of the dome 6a extends along a radial direction of the dome. Furthermore, the portion 6 comprises a base 6b, in particular cylindrical, from which the dome 6a extends. The thickness G of the base 6b extends along the axis A. The thickness G of the dome 6a and of the base 6b are equal and uniform. The dome 6a and the base 6b form a single layer, specifically hat-shaped.

FIG. 5 illustrates the portion 6 having a wedge-shaped cross-section. In particular, the portion 6 has a conical shape. More in particular, the portion 6 defines a cone without a base. The cone has a vertex which in this case belongs to the axis A. Here, the thickness G extends according to a direction that forms an angle with the axis A complementary to the opening angle of the cone.

FIG. 6 illustrates the portion 6 having a bevelled wedge-shaped cross-section, namely defining a trapezium without a base. In particular, the portion 6 defines a truncated cone without a base. This case differs from that of FIG. 5 only due to the presence of a bevel at the top of the cone.

FIG. 7 illustrates the portion 6 having a rectangular section as in the case of FIG. 3. Here, however, the thickness G extends according to a transverse direction with respect to the axis A, more precisely forming a 45° angle with the axis A.

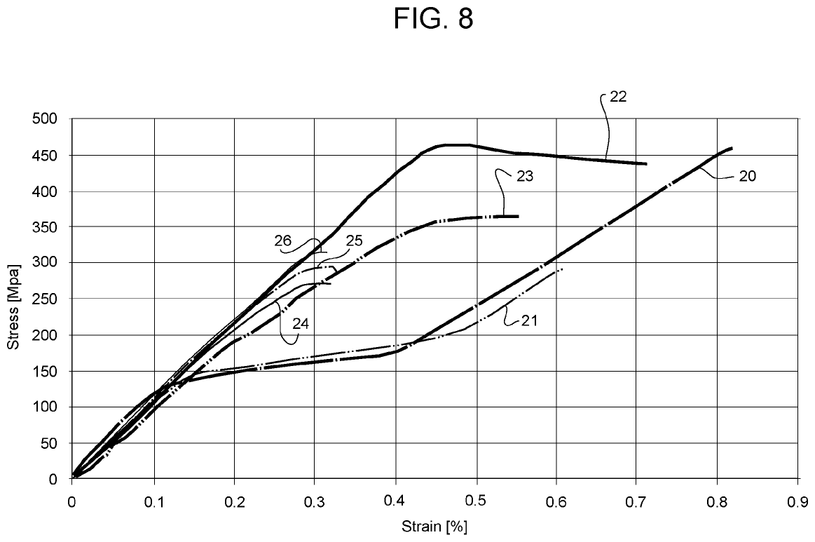

FIG. 8 illustrates for comparison the stress-strain diagrams relative to the examples of FIGS. 3-7, possibly according to different thicknesses of the portion 6. The tensile strength of the material used for the aforesaid examples, in conditions of full densification (part 7 of the body 2), is approximately 830 MPa.

The reference numbers 20 and 21 indicate lines relative to the case of FIG. 3 with uniform thicknesses of 100 and 200 micrometers respectively. The reference numbers 22, 23 indicate lines relative to the case of FIG. 4 with uniform thicknesses of 100 and 200 micrometers respectively. The reference numbers 24, 25, 26 indicate lines relative to the cases of FIGS. 5-7, respectively, with uniform thickness G of 100 micrometers.

The lines 20, 21 highlight a plastic behaviour of the portion 6 starting from relatively low stress values (higher than approximately 130 MPa). Breakage occurs for relatively high strain values (higher than approximately 0.6%).

The lines 22, 23 also highlight a plastic behaviour but for higher stress values (over 300 MPa) than the lines 20, 21. Also here, the breakage occurs for relatively high strain values (higher than 0.5%) but lower than the lines 20, 21.

The lines 24, 25, 26 highlight a more fragile behaviour. The breakage occurs for relatively low strain values (approximately 0.33%) and stress values (between 260 and 330 MPa). The ultimate tensile strength is increasing for the lines 24, 25, 26 in succession.

The greater the thickness G of the portion 6, the greater the decrease in mechanical strength of the body 2.

The minimum thickness G of the portion 6 is equal to the minimum thickness of a layer that can be manufactured by the machine.

Preferably, the thickness G of the portion 6 is lower than 800 micrometers, more preferably between 60 and 400 micrometers, and specifically between 100 and 200 micrometers.

Alternatively or additionally, the thickness G of the portion 6 is lower than 16-20 times the minimum thickness, specifically 1-8 times, more specifically 1-4 times.

Furthermore, preferably, the volume of the portion 6 is lower than 1% of the overall volume of the body 2, specifically between 0.02% and 0.05%.

A reduced thickness G and/or volume is favourable for a localized control of the properties of the manufactured body 2. In fact, the programmed breakage area is advantageously limited for reasons of dependability and repeatability. Excessively large weakened areas entail an undesired general weakening of the resulting product.

Modifications and variations can be made to the invention described above without departing from the scope defined by the claims.

One, some or all the steps of the process described above can be carried out by a computer and/or by the machine processing unit.

1-21. (canceled)

22. An additive manufacturing process for manufacturing a solid body designed to be delimited by a predefined outer surface, the additive manufacturing process comprising:
selecting at least one volume portion of the solid body, the at least one volume portion having a position surrounded at least partially by a remaining part of the solid body;
preparing a three-dimensional model of the solid body by a computer, in which the selected volume portion is modelled in said position as a further body detached from and independent of said remaining part;
setting the model in a data interface format readable by a processing unit of an additive manufacturing machine;
supplying the model in said data interface format to the processing unit;
selecting at least a process parameter of the additive manufacturing machine suitable for influencing the densification of the further body and of the remaining part;
applying differently the process parameter for production of the further body and the remaining part, such that the further body is less densified than the remaining part; and
operating the additive manufacturing machine according to application of the process parameter for producing the solid body according to the model, thus obtaining said predefined outer surface.

23. The additive manufacturing process according to claim 22, wherein application of the selected process parameter influences a mechanical strength of the further body, such that the further body produced is weakened with respect to the remaining part produced.

24. The additive manufacturing process according to claim 22, wherein application of the selected process parameter influences a treatment uniformity of the material of the further body, such that the further body produced has areas of material coupled with the remaining part and areas of material separated from the remaining part.

25. The additive manufacturing process according to claim 22, wherein the additive manufacturing machine operates with an electron beam fusion technology; a process parameter of the electron beam fusion technology being selected from at least one of:
electron beam focus deviation;
electron beam current;
electron beam speed; or
number of passages of the electron beam.

26. The additive manufacturing process according to claim 22, wherein the selected volume portion has a volume less than 1% of the volume of the solid body.

27. A product, comprising: a solid body obtainable by the additive manufacturing process according to claim 22.

28. A product, comprising:
a solid body delimited by an outer surface, the solid body including a first and a second inner portion with respect to the outer surface;
wherein the first portion is less densified than the second portion.

29. The product according to claim 28, wherein the first portion has a relative density less than 1 with reference to the second portion.

30. The product according to claim 28, wherein the first portion has a volume less than 1% of the volume of the solid body.

31. The product according to claim 28, wherein the first portion has a thickness between a minimum thickness of a layer that can be manufactured by the machine and 20 times said minimum thickness.

32. The product according to claim 28, wherein the first portion includes areas of material coupled to the remaining part and areas of material separated from the remaining part.

33. The product according to claim 28, wherein the first portion is weakened with respect to the second portion.

34. An additive manufacturing process of a solid body designed to be delimited by a predefined outer surface, the additive manufacturing process comprising:
selecting at least a volume portion of the solid body, the portion having a position surrounded at least partially by a remaining part of the solid body;
preparing a three-dimensional model of the solid body by a computer, in which the selected volume portion is modelled in said position as an empty space and comprises a part of said predefined outer surface;
setting the model in a data interface format readable by a processing unit of an additive manufacturing machine;
providing the model in said data interface format to the processing unit; and
operating the additive manufacturing machine to produce the solid body according to the model, thus obtaining said predefined outer surface.

35. The additive manufacturing process according to claim 34, wherein modelling of the volume portion influences the production thereof in terms of mechanical strength, such that the volume portion produced is weakened with respect to the remaining part produced.

36. The additive manufacturing process according to claim 34, wherein modelling of the volume portion influences the treatment uniformity of the material of the volume portion, such that the volume portion produced has areas of material coupled to the remaining part and areas of material separated from the remaining part.

37. The additive manufacturing process according to claim 34, wherein the selected volume portion has a thickness which extends along a first direction.

38. The additive manufacturing process according to claim 37, wherein the selected volume portion extends along a second and a third direction orthogonal to each other throughout the extension of the solid body; the first direction being orthogonal to the second and to the third direction and corresponding to a construction direction of the additive manufacturing machine.

39. The additive manufacturing process according to claim 37, wherein said thickness is uniform.

40. The additive manufacturing process according to claim 39, wherein the selected volume portion has a rectangular cross-section.

41. The additive manufacturing process according to claim 39, wherein the selected volume portion has an omega or wedge-shaped cross-section, possibly bevelled.

42. The additive manufacturing process according to claim 37, wherein said thickness is between a minimum thickness of a layer that can be manufactured by the machine and 20 times said minimum thickness.
